(19) United States
(12) Patent Application Publication
(10) Pub. No.: US 2020/0058210 A1
(43) Pub. Date: Feb. 20, 2020

(54) NOTIFICATION SYSTEM AND METHOD FOR ALERTING OF VALUED CONTENTS IN A VEHICLE

(71) Applicants: Michael B. WILLIAMS, Cincinnati, OH (US); Joseph J SEIBERT, Cincinnati, OH (US)

(72) Inventors: Michael B. WILLIAMS, Cincinnati, OH (US); Joseph J. SEIBERT, Cincinnati, OH (US)

(73) Assignee: Evenflo Company, Inc., Miamisburg, OH (US)

(21) Appl. No.: 16/342,447

(22) PCT Filed: Nov. 21, 2017
(86) PCT No.: PCT/US2017/062715

§ 371 Date: Apr. 16, 2019

Related U.S. Application Data
(60) Provisional application No. 62/426,140, filed on Nov. 23, 2016.

(51) Int. Cl. G08B 21/24; G07C 5/08; H04W 4/48; H04W 4/80; H04W 4/06; G08B 7/06; G08B 21/22

(52) U.S. Cl. CPC G08B 21/24; G07C 5/08; H04W 4/48; H04L 67/12; H04W 4/06; G08B 7/06; G08B 21/22; H04W 4/80

(57) ABSTRACT

A vehicle notification system for communicating with a driver of a passenger vehicle, after the driving journey has ended, that a child or valued object remains within the vehicle. A detection device detects the presence or restraint of a child or valued object, and transmits a presence/restraint status signal. A portable controller device attached to the OBD-II port has a transceiver that receives and re-transmits the presence/restraint status signal, and a microcontroller that interacts with the network of the vehicle to determine the status of the vehicle journey as being underway or ended. The controller also transmits a vehicle journey status signal. A drivers smartphone includes a microprocessor with software that configures the smartphone transceiver to receive the vehicle journey and presence/restraint status signals, and generates an alarm signal in response to a predetermined condition of the presence/restraint status and the vehicle journey status.

### FIELD OF THE INVENTION

This invention relates to devices for querying vehicle networks, and to a system for alerting a driver of valued contents in a vehicle.

### BACKGROUND OF THE INVENTION

There have been a number of efforts addressing the tragic deaths of children who have been mistakenly left in automobiles or vehicles after the driver had reached his/her desired destination and left the vehicle. The deaths have usually been caused by a buildup of excessive heat or excessive cold within the vehicle during the absence of the driver. Conventional infant car seats and toddler booster seats are intended to restrain the infant or toddler during transportation within the vehicle, and are typically designed so that the infant or toddler cannot by oneself release the seat belt or restraint. Infants and small children are rapidly susceptible to hyperthermia when subjected to the elevated temperatures within an enclosed vehicle, with sometimes fatal consequences.

Review of child accidental deaths cases due to hyperthermia in vehicles demonstrates that this usually occurs when the parent or caretaker has deviated from a usual routine with the child. For example, a different vehicle is used, or a different parent takes the child to a destination that day due to the exigencies of family and work life.

The prior art includes numerous references that suggest detecting the status of a vehicle's ignition and determining the presence of a child in the child safety seat, to alert the driver that the child is still in the child safety seat when the drive is ended, including U.S. Pat. Publication Nos. 2009/0079557 and 2011/0109450, and U.S. Pat. Nos. 6,104,293, 5,949,340, and 6,489,889, the disclosures of which are incorporated by reference. However, none of these references describe in specific detail how a device or a method using the device detects or determines the vehicle ignition status or state, using information collected from a network on the vehicle. There is, for example, no known mandated network message that identifies the position of the vehicle key in the ignition as in either the ‘on’ or ‘off’ position.

U.S. Pat. Publication 2009/0079557, published Mar. 26, 2009, the disclosure of which is incorporated by reference in its entirety, describes a warning system for signaling the presence of a child in an infant seat, the system being portable, at least in part, and generating and transmitting an alarm to the vehicle operator as a result of the operator having walked away from the vehicle and the infant remaining latched in the infant seat. This patent describes a wireless apparatus, including a transmitter associated with an infant latched into an infant seat and a receiver carried by the vehicle operator. The receiver measures the strength of a signal from the transmitter and generates an alarm signal to the operator when the signal strength falls below a prescribed level, thereby indicating that a child has been left unattended in the vehicle.

US Patent Publ. No. 2014/0052342 (Seibert), the disclosure of which is incorporated by reference, discloses a portable device that plugs directly into the OBD-II port of a vehicle that queries a vehicle network through the OBD-II port for the value of a parameter(s), and generating an alarm in response to a predetermined condition of the parameter(s), and a buckle status signal from a child restraint device of a safety seat. U.S. Pat. No. 9,417,078 (Seibert), the disclosure of which is incorporated by reference, describes a device, and a method, the device having an OBD-II port interface and a microcontroller that interacts with a vehicle network through the interface, including programming for querying successively the vehicle network for parameters, for retrieving values for the parameters. The parameters are monitored by querying repeatedly a predetermined or random pattern of PIDs, and inferring a vehicle journey status by comparing the responses to the querying against a predetermined set of inferring response or parameter values, such as (1) the absence of a response to query of a monitoring parameter, (2) a zero value, and (3) a non-changing, non-zero value. A confirming parameter that satisfies the comparison is further queried successively a plurality of times within a predefined term, against the same inferring response or parameter values, and, if satisfied, the vehicle journey is identified as ‘ended’.

Patent Publication 2003/0122662 (Quinonez) discloses an apparatus comprising (a) a child state detector for detecting the presence of a child within a baby car seat located within a vehicle; (b) a component selected from a group consisting of: (i) a door state sensor for detecting the state of a driver door of the vehicle and capable of being activated by an open driver door; (ii) a range detector for detecting the distance of a driver possessing a key ring remote from the baby car seat located within the vehicle and capable of being activated by removing the key ring remote a predetermined distance from the child state detector; (c) a control unit for generating an alarm signal when the selected component activates and provides a signal to the control unit; and (d) a power unit for supplying electrical power to the control unit.

U.S. Pat. No. 6,847,302 (Flanagan) discloses an object-proximity monitoring and alarm system for use with an object carrier, comprising: (i) at least one sensor adapted to determine whether the object carrier is occupied; (ii) a main transmitter in communication with the sensor; and a portable unit including a receiver and an alarm, wherein the main transmitter is operable to communicate to the portable unit receiver whether the object carrier is occupied based on input from the sensor, and the portable unit is operable to activate the alarm if the object carrier is occupied and the receiver is removed beyond a first predetermined proximity range of the main transmitter. Another embodiment discloses a child-proximity monitoring and alarm system for use with a child seat securable within a vehicle, comprising: (i) a detector assembly including a sensor and a second transmitter, wherein the sensor includes a weight-sensitive mat adapted to determine whether the child seat is occupied and the second transmitter is operable to transmit a first indication that the child seat is occupied responsive to input from the sensor; (ii) a base unit including a transceiver operable to receive the first indication that the child seat is occupied and, responsive thereto, to transmit a second proximity-sensitive indication that the child seat is occupied; and (iii) a keychain fob housing an alarm and a receiver operable to receive the second proximity-sensitive indication that the child seat is occupied and to activate the alarm if the fob receiver is removed beyond a first predetermined proximity range of the main transmitter while the child seat is occupied, wherein the base unit is configured to transmit the first proximity-sensitive indication that the child seat is occupied only if the child seat is within a second predetermined proximity range of the base unit.

U.S. Pat. No. 6,922,154 (Kraljic et al) discloses a safety device comprising: (a) a seat belt interlock has a male connector and a female connector; (b) said female connector of the said seat belt interlock, for when in use, receiving a vehicular seat belt male connector; (c) said male connector of said seat belt interlock, for when in use, connecting with a vehicular seat belt female connector; (d) said seat belt interlock has detection means for determining when said male connector of said seat belt interlock is connected with the vehicular seat belt female connector and the said female connector of the said seat belt interlock is connected with the vehicular seat belt male connector; (e) the said seat belt interlock has radio frequency signal transmitter means to alert at least one person that the said male connector of the said seat belt interlock is connected with the vehicular seat belt female connector while the said female connector of the seat belt interlock is connected with the vehicular seat belt male connector, and a signal receiving means which is separate from the said transmitter.

U.S. Pat. No. 7,378,974 (Bassett) discloses a child seat safety system comprising: (i) a main controller for attachment to a seat; (ii) at least one alerting device having at least one lighting device provided in signal-receiving relationship to said main controller for activation by said main controller; (iii) said at least one alerting device comprises at least one main alerting device and at least one buckle alerting device, said at least one buckle alerting device comprises a housing and a central opening extending through said housing; and (iv) at least one of a pager and a cell phone provided in signal-receiving relationship to said main controller for activation by said main controller.

There remains a need to provide a convenient, portable, effective, and very reliable system for use by drivers of vehicles for determining the end of a driver's journey, and communicating to or alerting the driver when a child or pet remains present in a child safety seat or other compartment of the vehicle after the journey has ended.

Modern vehicles use onboard data networks to communicate useful information between microcontrollers found both within the vehicle and within devices attached to the OBD-II port. Microcontrollers communicating on the vehicle network “query” (request information from) other microcontrollers on the network by transmitting a request message containing a predefined Parameter Identifier (PID). One or more microcontrollers on the network respond to such a query by transmitting a response message containing the value of the requested vehicle operating parameter (for example, engine revolutions per minute (RPM) or vehicle speed).

U.S. law, and by law in other countries, mandates the reporting of standard parameters by the vehicle network when queried via a device connected to standard sockets (Pins 6 and 14, in the case of the CAN protocol) on the OBD-II port. ISO 15765 defines the Controller Area Network (CAN) protocol that is mandated for use in North American passenger and light truck vehicles since 2008. Reference is made to http://en.wikipedia.org/wiki/OBD-II_PIDs. The OBD-II port has been a required feature on all passenger vehicles and light trucks sold in the US since Jan. 1, 1996. These networks use CAN and other communication protocols.

In view of the above, there remains a need to provide a convenient, more portable, effective system for use by drivers of vehicles for determining, or inferring with high predictability, the status of a driver's journey, indicating when the driver has ended the journey and has arrived at his/her desired destination, has turned off the operating systems of the vehicle, and will leave the vehicle. Such a convenient, portable and effective device or system could then be used in combination with a device that detects the presence of a child in a child safety seat or that detects the restraint status of the child in the child safety seat, so that an alarm can be generated that warns the driver when a child has been left secured into the child safety seat after the journey has ended.

There also remains a need for providing improvements in notifying parent-drivers and caregiver-drivers of the status of the vehicle journey, or the status of the child or pet, or some other valuable or sensitive object, as present or restrained in the vehicle, and in providing warnings when such child or pet, or some other valuable or sensitive object, remains present or restrained in the vehicle after the vehicles journey has come to an end, and the driver departs the vehicle.

### SUMMARY OF THE INVENTION

The invention relates to a system, and an associated method, for communicating with a driver of a passenger vehicle, after the vehicle's driving journey has ended, that a child, pet or valued object remains present within the vehicle.

The present invention provides a vehicle notification system for notifying a driver or other vehicle occupant that a child, a pet or a valued object remains present or restrained within the vehicle after journey of the vehicle has ended. The vehicle notification system can comprise:

at least one detection device including a means for detecting a presence or a restraint of a child, pet or valued object, within the vehicle, and a transmitter configured to transmit a presence/restraint status signal. The presence or restraint can be actual or implied;

a controller device, which can be a portable controller device that attaches to the On-Board Diagnostic II (OBD-II) port of the vehicle, including a microcontroller, a network interface, a transceiver. The microcontroller is configured to interact with the network of the vehicle to determine the status of the vehicle journey as being underway or ended. The transceiver is configured to receive the presence/restraint status signal transmitted by the detection device, and to transmit a vehicle journey status signal, and a presence/restraint status signal; and

a mobile communication device, which can include a smartphone in the possession of the driver or other vehicle occupant, that includes at least a microprocessor or computer that incorporates a software application, and a transceiver, wherein the software application configures the transceiver to receive the vehicle journey status signal and the presence/restraint status signal transmitted by the controller device, and wherein the software application generates an alarm signal in response to a predetermined condition of the vehicle journey status and the presence/restraint status.

In an embodiment of the invention, the transceiver of the smartphone is a near-range transceiver, capable of transmitting a wireless signal with the vicinity of the smartphone of up to 100 meters. A non-limiting examples of the transceiver include a Bluetooth® and Bluetooth® LE (Bluetooth® Smart) transceiver operating in the 2.4 GHz range, and an RF transceiver operating in the 400-900 MHz range.

In an embodiment of the invention, the software application configures the transceiver to transmit a notification signal while the software application is running on the smartphone, which can be received by the controller device, to notify the controller device that the smartphone is in the vicinity of the controller device. Typically the notification signal is transmitted intermittently by the smartphone, typically once every few seconds, every second, or more frequently, so that the controller device is aware of the presence or absence of the notification signal from the smartphone at any time. The controller device, described below, can be configured selectively to generate its own alarm signal in response to a predetermined condition of the vehicle journey status and the presence/restraint status, in addition to the alarm signal generated by the smartphone, or when the notification signal from the smartphone has not been received for some period of time.

The software application can be loaded into the memory or microprocessor of the smartphone by any well-known means, including by downloading and installing the software application from a website or file source through the internet or a wireless network. The software application can be configured by the user to be active on the smartphone at all times, or can be manually activated by the user. The transceiver of the smartphone can be configured on the smartphone to operate in the background while the software application is dormant or in hibernation. The transceiver can be configured to activate the software application in response the receipt of a signal transmitted by the controller device, including either of the vehicle journey status signal and the presence/restraint status signal.

The software application can also include a program for pairing and/or registering the particular smartphone on which the software application is running with the controller device, and vice versa.

The mobile communication device includes programming to generate an alert signal based on a condition of having received both an active status of the presence/restraint status signal that was re-transmitted by the controller device, and an ended status of the vehicle journey that was transmitted by the controller device. The alert signal generated by the mobile communication device can be a visual message or signal on a display or a light source, an audible message or signal, or an electronic broadcast of a message or signal to a third party mobile communication device or network device.

In an embodiment, the mobile communication device can be configured optionally to generate and transmit an acknowledgement signal to the portable controller device, to confirm the receipt by the mobile communication device of either or both of the vehicle journey status signal and the presence/restraint status signal, and can also notify the portable controller device that an alarm signal was generated.

The detection device can include any device for detecting a presence or a restraint of a child, pet or valued object within the vehicle can include a device for sensing or detecting the actual or inferred presence of the child, pet or valued object, based on some physical parameter of the child, pet or valued object. The detection device can include a detector or sensor for weight, body temperature, movement, or a live image. Non-limiting examples of such devices are described in U.S. Pat. Nos. 5,949,340 and 6,922,147, the disclosures of which are incorporated by reference in their entireties.

The detection device can also include a device for inferring the presence of the child, pet or valued object, based on the status of a restraint device as either being engaged or disengaged. Non-limiting examples of the restraint device can include a seat belt buckle, which can include a lap, shoulder or chest clip buckle for a passenger, booster, and/or child safety seat. The restraint device includes a restraint mechanism and a buckling detector that detects the buckling status of the at least one restraint device as either buckled or unbuckled, and a buckle signal transmitter for transmitting a buckle status signal.

In another embodiment, the detection device can also include an attachable device including a means for fastening or attaching the attachable device to child or other person, pet, or a valued object, and a transmitter or transceiver that can be activated manually or automatically when fastened or attached to transmit the presence/restraint status signal. Non-limiting examples of the means for fastening or attaching can include a pin, a clamp, an adhesive portion, a mechanical fastener (aka Velcro), a strap, and elastic band, and tied strings. Non-limiting examples of such devices are described in U.S. Pat. Nos. 5,939,988 and 7,106,191, the disclosures of which are incorporated by reference in their entireties.

In an embodiment, a chest clip for positioning and securing shoulder or harness straps in position has a restraint mechanism that includes a latch member and a buckle member securable to the latch member. The latch member includes an extending element, and the buckle member includes a body defining a cavity having a front opening, into which the latch extending element of the latch is inserted to a secured position for releasable securement of the latch member to the buckle member. The buckling detector is secured to either one of the body of the buckle member or the latch member, and includes a detector switch, a replaceable battery, and a radio frequency (RF) transmitter.

The detection device is in an active state when the child, pet or valued object is detected as present or restrained within the vehicle, actual or inferred. In the active state, the detection device transmits an “active” signal, indicating that the device has detected the presence or restraint of the child or pet. In some embodiments, the transmission of the “active” signal can be repeated one or more times, including intermittently, while the child or pet detection device is in the active state. The child or pet detection device can also be configured for an inactive state, when the child or pet is not present or not restrained in the child safety seat. In the inactive state, the child or pet detection device can transmit an “inactive” signal, indicating that the device does not detect the presence or restraint of the child or pet. If the child or pet detection device is configured to repeat the “active” signal one or more times or intermittently in the active state, then the device will cease or will have ceased the further transmissions of the “active” signal when in the inactive state.

The controller device can include a portable controller device which is configured to plug into the OBD-II port of a passenger vehicle or light truck, or a native or on-board controller device that interacts with the vehicle network, to provide a reliable device and method for accurately inferring and determining the journey status of a passenger vehicle, for substantially all makes and models of automobiles and trucks in the world, and that comply with OBD-II standards. The portable controller device is configured to plug into the On-Board Diagnostic II (OBD-II) port of a passenger vehicle, light truck, or commercial vehicle or truck, (collectively referred to as a vehicle or passenger vehicle unless the context states or suggests otherwise) and is placed into electronic communication with the vehicle network via one or more pins of the OBD-II port. The OBD-II port has been a required feature on all passenger vehicles and light trucks sold in the US since Jan. 1, 1996.

The controller device serves as a proxy transmitter for the presence/restraint detection device, capable of re-transmitting the presence/restraint status signal continuously and reliably.

As described above, the controller device can be configured to continuously monitor for a notification signal transmitted by the mobile communication device, or smartphone. If the controller device has not detected a notification signal from the smartphone for more than a period of time, the controller device can be configured to emit an alarm signal in response to the predetermined condition of the vehicle journey status and the presence/restraint status, under the presumption that the smartphone and its owner/possessor has move away from the vicinity of the vehicle, or that the smartphone has been turned off or its battery has been exhausted, or the software program has been turned off or deactivated. In an alternate embodiment, the smartphone software program may be programmed to detect whether the controller device is engaged and detecting the smartphone presence. In this embodiment, the alarm signal may only be selected to be emitted upon the signal between the controller device and the smartphone being lost after the initial “handshake” between the controller device and smartphone which may occur prior to the start of the vehicle journey or anytime thereafter while the journey is in progress or just ended.

The present invention also provides a method for notifying a driver or other vehicle occupant that a child, a pet or a valued object remains present or restrained within the vehicle after journey of the vehicle has ended, comprising the steps of:

i) providing a detection device, controller device, and smartphone operating the software program, as described above;

ii) positioning a child, pet or valued object in a vehicle, detecting by the detection device that the child, pet or valued object positioned in the vehicle is present or restrained, and transmitting by the transmitter of the detection device, an active detection signal;

iii) receiving by the transceiver of the controller device, the active detection signal sent by the detection device, and re-transmitting intermittently by the transceiver of the controller device, the active detection signal for receipt by the smartphone;

iv) receiving by the transceiver of the smartphone, the active detection signal sent by the controller device, and entering an active detection status into memory;

v) driving the vehicle by a driver to establish a vehicle status as ‘underway’;

vi) terminating by the driver of the vehicle journey, and detecting the change in vehicle journey status as ‘ended’, and transmitting by the controller device of the ended journey status signal for receipt by the smartphone;

vii) receiving by the transceiver of the smartphone, the ended journey status signal sent by the controller device, and entering an ended journey status into memory;

viii) determining by the smartphone the condition that the journey has ended and that the child, pet or valued object remains present or restrained in the vehicle, and activating an alert signal for a predetermined period of time;

ix) terminating the alert signal if the child, pet or valued object is removed or released from the vehicle, and an inactive detection signal transmitted by the detection device, and re-transmitted by the controller device, is received by the smartphone; or

x) generating an alarm signal by the smartphone if an inactive detection signal is not received by the smartphone within the predetermined period of time.

In an embodiment of the invention, the controller device, once received, intermittently and continuously transmits the vehicle journey status signal and the presence/restraint status signal. In another embodiment of the invention, the controller device terminates the transmission of the ended journey signal after a set time if the presence/restraint status was inactive when the vehicle journey ended, or if the presence/restraint status changed from ‘ active’ to ‘inactive’ after the vehicle journey status changed from ‘underway’ to ‘ended’.

The “alert” time, also referred to as a wait time, is the time after which the smartphone has received a transmission of an ended journey status signal while the presence/restraint status signal is active.

The smartphone alarm signal generates an alarm that can be a visual message or signal on a display or a light source of the smartphone, an audible message or signal, or an electronic broadcast of a message or signal to a third party mobile communication device or network device. The third party can be any other person or entity; for example, a second parent or child care provider, emergency personnel, or a central call center. The software application can be configured, including by set-up options established by the user, to contact two or more third parties consecutively, or sequentially after a set time, until the smartphone received the inactive detection signal.

In an embodiment of the invention, the portable controller device includes a microcontroller configured with programming, for querying the vehicle's network for parameters, by the use of one or more PIDs; for querying and retrieving, and optionally storing, a response of a value of the parameter or parameters returned by the vehicle's network, or the lack of a response, to the network queries employing the associated PIDs; and for inferring the vehicle's journey status based upon the response of the network of the value of the parameter, or absence of a response, and to determine if the vehicle's journey status is ‘underway’ or is ‘ended’, or to determine if the vehicle's journey status has changed from ‘underway’ to ‘ended’, or has changed from ‘ended’ to ‘underway’, or both. The microcontroller can be configured for querying and retrieving, and optionally storing, a response of the network of a value of a parameter, or a plurality of parameters returned by the vehicle's network in response to queries containing a Parameter Identifier (PID) associated with each parameter.

In an embodiment, the value of the parameter(s) can be used to infer, and more particularly, to confirm or to determine, that the vehicle and the driver have arrived at a destination, and that the journey has ‘ended’, or are ‘underway’ on the journey. From the inferred or determined journey status as ‘ended’ or ‘underway’, the controller device can be configured to broadcast the inferred or determined status of the journey, as “underway’ or ‘ended’, and both, to the driver, to another device, or to a communication system, or to emit an alarm or warning signal in at least partial response to the inferred or determined status of the driver or the journey, as “underway’ or ‘ended’, and both; for example when a journey is inferred or determined to have ‘ended’, and the controller device, or another device in broadcast communication with the controller device, indicates the actual or implied presence of a child in the vehicle, including in a child safety seat within the vehicle.

In an embodiment, the vehicle network includes the CAN network, or any standardized communication protocol.

In an embodiment of the invention, a portable controller device can include an alarm generator generates an visible, vibratory, or audible alarm in response to an alarm signal generated by the controller device in response to a predetermined condition of the vehicle journey status and the presence/restraint status.

In an embodiment, the one or more parameters to be queried use a plurality of predefined and distinct PIDs. This can include querying parameters associated with two to ten distinct PIDs, which can include two to five PIDs, and including three to five PIDs.

In an embodiment, a predetermined inferring response or parameter value that may be returned by a vehicle's network in response to a query of a parameter, is at least one of an absence of a response to the querying, or two, three, or more consecutive identical, non-zero values in response to successive querying of a parameter. Optionally, a predetermined inferring response or parameter value can be a zero value.

In an embodiment, the controller can be configured for a monitoring mode, while a vehicle journey status is ‘underway’, where the controller queries, or is configured to query, a predetermined monitoring parameter on the network, including one or more predetermined monitoring parameter. The microcontroller is configured to compare the response or parameter value returned by the network to the query of the predetermined monitoring parameter, against a predetermined inferring response or parameter value that includes an absence of a response to the query of the predetermined monitoring parameter. When the returned response or parameter value of the network is the absence of a response by the network to the query of the predetermined monitoring parameter, the vehicle journey that was ‘underway’ is inferred to have changed to ‘ ended’, and the predetermined monitoring parameter is defined as a candidate parameter.

In another embodiment of the invention, the microcontroller is configured to monitor for a response from the network to the query of the predetermined monitoring parameter, and to infer that the vehicle journey that was ‘underway’ has changed to ‘ended’ if there is an absence of a response from the network to the query of the predetermined monitoring parameter.

In yet another embodiment of the invention, the microcontroller is configured to monitor for a response from the network to the query of the predetermined monitoring parameter, and to infer that the vehicle journey that was ‘underway’ has changed to ‘ended’ if the value of the response from the network to the querying of the predetermined monitoring parameter is two, three or more, successive, identical non-zero values.

In another embodiment of the invention, the microcontroller is configured for querying during a mode of using the microcontroller for a parameter or plurality of parameters using a PID, including one or a plurality of PIDs, one or more times for any one or more of the PIDs, within a brief temporal period. This can include querying during a mode using the PID, or each of the plurality of PIDs, from two to ten times, including two to five times, and including three to five times, within a temporal period of about 10 seconds or less, more typically of 1 second or less, including about 0.5 seconds or less. In a further aspect of the invention, the querying of a parameter using a PID, including a plurality of PIDs, from one or more times within a brief temporal period, can include querying for successive temporal periods of time. The plurality, or more than one, predetermined monitoring parameter can include the first predetermined monitoring parameter, and a second additional one or more predetermined monitoring parameter.

In a further embodiment, the microcontroller is configured, in a method, to include a monitoring mode that queries one or more, including a plurality of, predetermined and distinct parameters (“monitoring parameters”) on the network, and screens or tests each response or parameter value returned by the network to the query of the monitoring parameters, against a predetermined response or parameter value (“an inferring response or value”). If the returned response or parameter value is or satisfies the inferring response or value, then the controller and programming has established an inference that a vehicle journey that is presently or was ‘underway’, has changed to ‘ended’. If the response or parameter value returned against a monitoring parameter is the inferring response or value, such monitoring parameter is identified as a candidate parameter for further evaluation to confirm the inference that the journey status has changed to ‘ended’.

The invention can include a method for inferring that a vehicle having a vehicle journey status of ‘underway’ has ‘ended’, comprising in a monitoring mode the steps of: a) querying continuously (or successively) a predetermined monitoring parameter on the network; and b) comparing a response to the query of the predetermined monitoring parameter, returned by the network, against a predetermined inferring response or parameter value that infers that the vehicle journey has changed to ‘ended’. In one embodiment of the invention, the predetermined inferring response or parameter value comprises the absence of a response to query of the monitoring parameter. In another embodiment of the invention, the predetermined inferring response or parameter value is the absence of a response to query of the monitoring parameter. In a further embodiment of the invention, the predetermined inferring response or parameter value can be the absence of a response to query of the monitoring parameter, or can be two, three or more successive, identical non-zero values in response to query of the monitoring parameter.

The method of the invention can further include c) identifying the monitoring parameter as a candidate parameter if the response to the query of the monitoring parameter is the predetermined inferring response or parameter value.

In another embodiment of the invention, the method of the invention alternatively includes c) inferring that a vehicle having a vehicle journey status of ‘underway’, or that was ‘underway’, has ‘ended’ when the response to the query of the predetermined monitoring parameter is the predetermined inferring response or parameter value; and d) identifying the predetermined monitoring parameter as a candidate parameter.

In a further embodiment of the invention, the method of the invention alternatively includes c) inferring that the vehicle journey that had a status of ‘underway’, or was ‘underway’, has changed to ‘ended’, when the returned response or parameter value by the network is the absence of a response by the network to the query of the predetermined monitoring parameter; and optionally d) defining the predetermined monitoring parameter as a candidate parameter.

The invention can further include a method for inferring that a vehicle having a vehicle journey status of ‘underway’ has ‘ended’, comprising in a monitoring mode the steps of: a) querying, preferably continuously or successively, a predetermined monitoring parameter on the network; and b) monitoring for a response from the network to the query of the predetermined monitoring parameter. The method can further include c) inferring that the vehicle journey that was ‘underway’ has changed to ‘ended’ when there is an absence of a response from the network, or there are two, three, or more successive identical, non-zero values, returned from the network to the querying of the predetermined monitoring parameter.

The first predetermined monitoring parameter can be monitored by testing (for example, by comparing) the response returned by the network against a first predetermined inferring response or value. In another embodiment, the first predetermined monitoring parameter can be monitored or by testing independently and individually the response returned by the network against the first predetermined inferring response or value, and a second one or more predetermined inferring response or value. If at least one of the first predetermined inferring response or value, and the second additional one or more predetermined inferring response or value, is satisfied by the response returned by the network for the first predetermined monitoring parameter, then the vehicle journey that was ‘underway’ is inferred to have changed to ‘ended’. Likewise, a second additional predetermined monitoring parameter can be monitored by testing the response returned by the network against a first predetermined inferring response or value for said second additional predetermined monitoring parameter, which can be the same or different from the first predetermined inferring response or value tested against the first predetermined monitoring parameter, or by testing independently and individually the response returned by the network against said first predetermined inferring response or value, and a second additional one or more predetermined inferring response or value. If at least one of said first predetermined inferring response or value, and said second one or more predetermined inferring response or value for said second additional predetermined monitoring parameter, is satisfied by the response returned by the network for the second additional monitoring parameter, then the vehicle journey that was ‘underway’ is inferred to have changed to ‘ended’. The first predetermined monitoring parameter or the second additional one or more predetermined monitoring parameter that has been satisfied by the response returned by the network, is defined as a candidate parameter.

The microcontroller and method also includes a confirming mode or step that further queries the candidate parameter one or more times, including a plurality of times in succession, within a predefined term, and tests each response or parameter value returned by the network for the query of the candidate parameter against an inferring response or value. If each response or parameter value returned during the predefined term for such candidate parameter is also an inferring response or value, then the journey status is deemed to have changed to ‘ended’. In an aspect of the invention, the inferring response or value of the confirming mode or step is the same predetermined inferring response or value of the monitoring mode or step that, when satisfied, defined the candidate parameter.

In a further aspect of the invention, the storing of a value of a parameter, including a plurality of parameters independently, for one or more times within a brief temporal period, can including storing a plurality of the most recently collected values of a parameter or parameters.

In another aspect of the invention, the microcontroller can be configured, for example with programming, for analyzing or performing an algorithm against the retrieved (and optionally stored) value of a parameter or parameters, queried by using one or more predefined PIDs, and of the plurality of parameters, that are returned by the vehicle's network, and inferring the vehicle's journey status from the collected (and stored) parameter values, to determine if the vehicle's journey status is ‘underway’, or is ‘ended’, or to determine if the vehicle's journey status has changed from ‘underway’ to ‘ended’, or has changed from ‘ended’ to ‘underway’, or both.

In a further aspect of the invention, an inference can be made, from a plurality of successive parameter responses or values returned by querying the network using one or more associated PIDs, termed an inferring response or value, that a vehicle journey that had been ‘underway’ has changed to ‘ended’, when (1) two or more successive returned parameter values of a queried PID is zero, or (2) two or more successive returned parameter values of a queried PID have identical non-zero values; or (3) the vehicle network fails to reply to the two or more successive queries for a parameter; or a combination thereof.

Another aspect of the invention is the use of unique identification codes for each restraint device of an equipped child safety seat, with appropriate recognition and tracking of said seats by the portable or native controller device, such that false positive alarms will not occur due to proximity to another vehicle using the same or similar system.

Another aspect of the invention is the ability for a single unique equipped seat or multiple such seats to be ‘learned’ and recognized by multiple portable controller devices, such that, for example, within a family or carpool, a seat could be moved from one system-equipped vehicle to another system-equipped vehicle freely without regard for ‘re-learning’ the seat by the system, once first ‘learned’ and recognized by each given portable controller device. This allows the safety feature to be always available without further action by a possibly distracted parent or caregiver when moving seat(s) between appropriately equipped family or carpool vehicles that have previously ‘learned’ a given unique seat(s).

Another aspect of the invention is the ability for the portable controller device to be moved from one vehicle to another, for example, when taken on vacation for use within a rental car, or for use by a rental car agency fleet, yet still retain in nonvolatile memory the ‘learned’ seats. A parent or caregiver can unplug the portable controller device at home, install it in seconds in a rental car, and use it with the family's equipped child safety seat(s) previously learned, without further action required while on vacation, then return home and return the portable controller to the original vehicle, all the while enjoying the safety granted by the system and requiring no repeat ‘learning’ of the car seat(s) used.

The invention also relates to a method for inferring that a vehicle having a vehicle journey status of ‘underway’ has arrived at a destination, indicating that the vehicle journey status is ‘ended’, comprising the steps of: a) querying successively a vehicle network for one or more parameters using associated PIDs; b) retrieving a plurality of parameter values returned by the network for the one or more queried PIDs; c) inferring that the vehicle has arrived at the destination, and that the vehicle journey status is ‘ended’, by determining from the plurality of retrieved parameter values of the one or more queried PIDs when at least one of the following occurs: (i) a predetermined number of successive zero retrieved parameter values for the one or more queried PIDs; or (ii) a predetermined number of successive identical non-zero retrieved parameter values for one or more PIDs; or (iii) no response (absence of a response) after querying using the one or more PIDs; or a combination thereof.

The one or more PIDs can comprise or consist of a plurality of the PIDs, including two to five PIDs, and the plurality of successive retrieved parameter values includes two to ten successive retrieved values, within a temporal period of about 10 seconds or less, including 1 second or less.

Another aspect of the invention is to postpone or “withhold” a status of a journey as “underway”, and the monitoring of parameters in the monitoring mode, until the vehicle has been driven for a minimum distance (for example, at least 0.01 mile) or for a minimum vehicle speed (to at least 5 miles per hour (mph)). The postponing or withholding of a journey as underway can distinguish a short term driving of the vehicle, for example, to back the vehicle out of the garage into the driveway, or when a parent needs to turn off the vehicle temporarily to lock a door in the residence with a key on the same key rings as the vehicle.

### BRIEF DESCRIPTION OF THE DRAWINGS

FIG. 1 shows a table (Table B) illustrating vehicle network traffic between a portable controller device plugged into the OBD-II port and the vehicle's ECUs, including monitoring and confirming the parameter ‘RPM’ for an inferring parameter value of zero that determines the vehicle journey has changed from ‘underway’ to ‘ended’.

FIG. 2 shows a table (Table C) illustrating monitoring and confirming the parameter ‘RPM’ for an inferring parameter value of an identical, non-zero value that determines the vehicle journey has changed from ‘underway’ to ‘ended’.

FIG. 3 shows a table (Table D) illustrating monitoring and confirming the parameter ‘VEHICLE SPEED’ for an inferring parameter value of “no response” that determines the vehicle journey has changed from ‘underway’ to ‘ended’.

FIG. 4 shows a table (Table E) illustrating monitoring and confirming the parameter ‘RUNTIME’ for an inferring parameter value of zero that follows a non-zero parameter value, which determines the vehicle journey has changed from ‘underway’ to ‘ended’.

FIG. 5 shows a table (Table F) illustrating monitoring and determining that the vehicle ECU has “reset” using an inferring parameter response of “no response” for the parameter ‘RPM’.

FIG. 6 illustrates child seat-vehicle safety apparatus and system of the present invention employed in a passenger vehicle, including a restraint device associated with the child safety seat, and a portable controller device that attaches to the On-Board Diagnostic II (OBD-II) port of the vehicle, and a smartphone.

### DETAILED DESCRIPTION OF THE INVENTION

### Definitions

As used herein, a child safety seat is a dedicated or combination child seat, a booster seat, a convertible car seat or other similar seat for transporting a baby, infant, toddler or child in a vehicle.

As used herein, a buckle is the part of a restraint mechanism of the child safety seat or a chest clip, and is associated with one or more belt webbing straps. A latch is typically manually secured to the buckle by a parent or caregiver. The buckle typically can include a release button, typically though not necessarily colored red, for releasing the latch.

As used herein, the latch is a part of the restraint mechanism that slides into the buckle and mechanically engages the buckle, and is also associated with one or more belt webbing straps or retaining elements.

As used herein, “memory”, unless otherwise specified, can include one or more processor-readable and accessible memory elements and/or components that can be internal to a processor or controlled device, or external to the processor or controlled device, can be accessed via a wired or wireless network, and can be non-volatile or volatile.

As used herein, “programming” stored upon and read by a computer, microprocessor or controller includes only non-transitory computer-readable media, comprises all computer-readable media, with the sole exception being a transitory, propagating signal.

As used herein, a journey of a vehicle that is “underway” is characterized by the driver embarking on the journey, being seated in the driver's seat of the vehicle, and having energized the engine or other movement motor, and/or preparing to operate and drive, or operating or driving, the vehicle for movement along a road or highway to a destination. As used herein, a journey of a vehicle that is “ended” is the state of the journey at any time the vehicle is not “underway”, either before or after the “underway” state. The vehicle is ended when the engine has been turned to off, the ignition has been turned to off, and/or the vehicle ECUs and network have been powered down to off.

Within this description, the value of a vehicle's operating parameter (for example, engine RPM or vehicle speed), as provided by one or more microcontrollers in the vehicle network, in response to a query, will be referred to as a “value” or a “parameter value”. The Parameter Identifier contained within the query message transmitted to the vehicle network when querying for a given parameter will be referred to as a “PID”.

### Vehicle Networks and Parameters

The details of operation of the vehicle networks can vary from manufacturer to manufacturer, and the usefulness of a parameter of vehicle operation, including engine operation, to indicate or infer that the vehicle's engine, ignition system, or ECU network has been turned off, can vary between different types, makes or models of vehicles or automobiles, including, by non-limiting example, variations between vehicles with internal combustion engines, hybrids, start/stop equipped vehicles, and all-electric cars.

The response or value of a vehicle operating parameter returned by the vehicle's network when queried using a corresponding Parameter Identifier (PID), will vary during normal vehicle operation (while the vehicle journey is ‘underway’). These parameter values are determined by a sensor or detector on the vehicle, and reported to a network controller. Such varied values of PIDs during the normal operation of the vehicle, while the journey is underway, are termed dynamic values, and can be used to infer and determine that the vehicle journey is ‘underway’, and that the journey status has changed from ‘ended’ to ‘underway’. Typically, the response returned by a network to a query of a parameter to the network, is sent, and received by the controller, within a brief period of time, termed a response time, of up to about 500 milliseconds (msec), more typically up to a response time selected from the group consisting of 250 msec, 200 msec, 100 msec, and 50 msec.

In an aspect of the invention, a first predetermined monitoring parameter can be selected from the group consisting of RPM, Vehicle Speed, and RUNTIME. In a further aspect of the invention, the first predetermined monitoring parameter can be selected from the group consisting of the PIDs listed in Table A. In yet another aspect of the invention, a second additional one or more predetermined monitoring parameter can be selected from the group consisting of the PIDs listed in Table A. The second additional one or more predetermined monitoring parameter can also be selected from the group consisting of RPM, Vehicle Speed, and RUNTIME. The second additional one or more predetermined monitoring parameter is typically a different parameter than the first predetermined monitoring parameter.

The return by the network of non-repeating or non-identical, non-zero values of fuel pressure, fuel delivery rate, vehicle speed, and other parameters, in response to querying using the parameter PIDs, can be used to infer and determine that the vehicle journey is ‘underway’. For example, the parameter “RUNTIME’ can infer that a vehicle's journey status has changed from ‘ended’ to ‘underway’ when a non-zero value is returned after the RUNTIME value has been zero and the journey status is ‘ended’.

For example, in the case of an engine's revolutions per minute (RPM), a sensor in the engine detects repeatedly and continuously the engine's actual RPM, and provides or reports it to the vehicle network. When a query for RPM is received, the network reports a value representative of the actual engine RPM, termed a “dynamic value”. When the ignition key of a vehicle with an internal combustion engine (ICE) is turned to ‘off, the engine stops running and the actual RPM goes to zero. In some makes and models of vehicles, the response value of the vehicle network to a query for RPM is immediately zero as a direct result of the RPM sensor detecting that the actual RPM is zero. But, for some makes and models of a vehicle, after the engine with an ICE is turned ‘off and the engine stops running, it has been learned that the response value of the vehicle network to a query for RPM may not immediately be zero, but rather may be an identical non-zero value, from one query of the RPM PID to the next query, or over the several next queries, of the RPM PID. The identical non-zero value may be the last dynamic value of the PID just before the engine or ignition is turned off. Thus, the response values for RPM may be a series of identical, non-zero RPMs, despite the actual engine RPM having gone to zero. The response by a network of two or may be three identical non-zero parameter values for any given series of queries, is very rare, though may be not impossible, during normal vehicle operation while the vehicle journey is underway. However, three, four, five, or more successive identical non-zero dynamic parameter values would be extremely improbable. While such a sustained response pattern might therefore reasonably imply a journey ‘ended’ status in certain ICE vehicles, in other vehicles it may not. Accordingly, in some embodiments of the disclosure, a sustained response pattern such as this may be followed with a check of secondary parameters to insure that a false positive is not indicated.

For other makes and models of a vehicle, after the engine with an ICE is turned ‘ off’ and the engine stops running, the response of the vehicle network to a query for RPM may go to a value of zero but only after a period of time of up to 30 seconds (after engine shutdown) during which time response value may be constant (identical series of non-zero values as mentioned previously) or may increment in value.

And for other makes and models of a vehicle, after the engine with an ICE is turned off and the engine stops running, the vehicle network simply stops replying to the parameter query; no response is given by the network when queried.

Another type of vehicle, a hybrid vehicle, has both an electric motor (power system) and a gasoline- (or diesel-) powered IC engine that is turned off (RPMs go to zero) by the vehicle's control systems when the vehicle is powered by the electrical motor. Yet another type of vehicle, an All-Electric car, has no internal combustion engine (and therefore reports no Engine RPM parameter value). And co-called “Start/Stop vehicles” turn off the internal combustion engine if the vehicle is stopped for an extended period of time in transit. A portable controller device, and a method, of the present invention is useful for inferring and/or confirming the journey status of a vehicle that is selected from the group consisting of a vehicle with an internal combustion engine, a hybrid vehicle, and a start-/stop-equipped vehicle. Typically such vehicle also is of a make and model that complies with OBD-II standards or equivalent networking standard.

One can understand and appreciate, based on the above cases, that querying solely for a “zero” value of RPM as an indication that the ignition has been turned ‘on’ or ‘off, or that the journey status is ‘underway’ or ‘ended’, may be sufficient for some makes and models of vehicles including vehicles with an ICE, a start/stop vehicle, and a hybrid vehicle, but would not accurately imply vehicle journey status for a broader number of, if not all, types (including vehicles with an ICE, a start/stop vehicle, and a hybrid vehicle), makes and models of vehicles, such as would be required of a commercial, consumer product for determining vehicle journey status by querying a vehicle network.

Another parameter example is the parameter Run Time Since Engine Start (or “RUNTIME”). RUNTIME has been mandated (by law or regulation) to be set to zero upon engine OFF state. Inclusion of the parameter RUNTIME as an engine operating parameter can enable the portable controller device to be used with a broader variety, make and model of vehicle to indicate engine or vehicle operation status and journey status. Nevertheless, it has been determined that some vehicle manufacturers set the Run Time to zero immediately upon engine shutdown, while some vehicle manufacturers simply stop replying to the parameter query, and others vehicle manufacturers set the Run Time to zero but not immediately, and rather up to 30 seconds or longer after engine shutdown. In the interim the value either is not replied to, or remains constant, or can continue to increment. In addition, it has been learned that an incrementing value for RUNTIME, reported in seconds, may not be updated and reported to the network at each increment, and may only be reported every 8-10 seconds of operation, such that successive RUNTIME values returned after querying may be identical values over a period of several seconds of time, and then may increment in value by the duration of said period (that is, 8-10 seconds) at the next value returned.

The parameter Vehicle Speed is reported over the vehicle network as the vehicle's actual moving velocity or speed. Ordinarily, a vehicle during a journey may on numerous occasions and for extended times be stationary (e.g., at a stop sign or stop light). Consequently, a vehicle speed of zero is ordinarily not a useful or reliable parameter to indicate that a journey has ‘ended’. Each make of vehicle has its own mechanism(s) for detecting the vehicle's speed, and for reporting or displaying the vehicle speed. Nevertheless, inclusion of the parameter Vehicle Speed as a vehicle operating parameter enables the portable controller device to be used with a broader variety and make of vehicle for implying vehicle journey status. Numerous type, makes and models of vehicles will fail to return a response to a query once the vehicle has been turned off and the journey has ‘ended’. It has been determined that Vehicle Speed reporting can vary between various manufacturers, and by itself may not be a reliable indicator of journey status. For example, one major manufacturer's vehicles report vehicle speed as a non-zero value over the CAN network even at initial vehicle engine start when the vehicle is stopped (not moving) and the transmission is in ‘Park’. However, in a large number of types, makes and models of vehicles, the PID Vehicle Speed fails to return a response upon query when the vehicle has been turned off (the engine has been turned off or powered down, and the ECU system shutdown.

### Use of Parameter Values to Infer and Determine Vehicle Journey Status

Given these learnings, it has been determined that queries using standard PIDs and proprietary, non-standard, or make- or model-specific PIDs generate characteristic responses from a vehicle network when queried immediately after the vehicle has been turned off (the engine has been turned off or powered down, and the ECU system shutdown), and a journey has ended: (1) a returned parameter value (or series of parameter values) can be immediately zero; or (2) a returned parameter value (or series of parameter values) can be zero, but possibly only after a period of time of 30 seconds or more; or (3) a repeated parameter value (or series of parameter values) can be an identical, non-zero value; or (4) the vehicle network simply stops replying to the query and no response is received.

Successive queries of PIDs after the vehicle journey has ended may return successive identical response values, which can be either zero, or non-zero identical values representing the last “real-time” parameter generated by the vehicle network. If a sufficient number of successive, identical response values for a PID are received, or no response is received at all, one can infer or predict, for certain PIDs, with very high certainty, that the vehicle network is no longer returning real-time “detected” (or “dynamic”) response values for these PIDs, and from which one can infer that the engine or its ignition system has been turned off, and that the vehicle and the driver have arrived at the destination and the journey status is ended.

A list of standard vehicle operation parameters as identified by their Parameter Identifier (PID) is shown in Table A, on the last page of this description. Parameters can include, without limitation, the fuel delivery rate, the engine rpm, the engine oil pressure, the vehicle's speed (typically represented as miles per hour or ‘mph’, or kilometers per hour), run time since engine start, fuel delivery pressure, intake manifold absolute pressure, throttle position, oxygen sensor voltage, engine coolant temperature, fuel trim, and mass air flow (MAF) air flow rate.

Although a single parameter of the vehicle's operation can be used for this inference, as explained by way of detailed examples above, the reliability of the inference of journey status (‘underway’ or ‘ended’) is improved by using a plurality of the parameters, including two parameters, three parameters, four parameters, or more, and by querying for and retrieving a plurality of parameter values from the network.

For example, in a certain class of vehicles, one might query Parameter 04 (Engine Load) in combination with Parameter 31 (Run Time Since Engine Start) to evaluate journey status.

In another class of vehicles, one might query Parameter 10 (Fuel Pressure) only if Parameter 03 (Fuel System Status) returned a valid response indicating an ICE motor is present; meanwhile Parameter 00 (supported PIDs) can be queried to validate continued Electronic Control Unit (ECU) operation from which vehicle journey status might be inferred.

It can be readily seen that a multitude of scenarios are possible that would allow reliable detection in near real time of vehicle journey status. Each scenario would involve the querying of one or more parameters as listed. The most useful parameters would vary depending on the class of vehicle queried.

A device targeted to just a small class or a single manufacturer's vehicle can determine the vehicle' journey status with a smaller subset of parameters, while giving up the ability to function properly across a wide range of types, makes and models of vehicles. A more general portable controller device, suitable for use in several or all types of vehicles, and across a wider range of vehicle makes and models, requires querying of a plurality of parameters to allow accurate vehicle journey status inference. This use of multiple parameters accommodates the variations that exist from vehicle to vehicle (make and models) in how stringently the vehicle's network adheres to the OBD-II standards in replying to queries.

In addition, real-world use requires that multiple responses that imply journey status be received before a particular journey status is confirmed. In real world operation, the network itself and the various on-board ECUs are busy processing queries and parameter values in the ordinary course of the operating the vehicle. The operation can include emergency or “high priority” events during which an on-board ECU may repeatedly request important operating parameter information about the vehicle and its operation. Excessive querying of the network should be avoided in order to not interrupt or overload the network during such high priority events. Vehicle ECUs can “reboot” or “reset” from time to time during a driving cycle while the journey is ‘underway’, or vehicle network responses are missed or delayed due to higher priority network traffic. The ECU reset will complete within a very short time, typically less than one second, and usually less than 0.6 seconds. Although these ECU resets are not frequent, they occur in most every vehicle in response to any number of conditions experienced by the ECU. When an ECU resets, a queried PID response to that ECU fails to return a respond. Any failure of the system to return a response to a PID query during an ECU reset cycle might infer falsely that the vehicle had gone from an ‘underway’ state to an ‘ended’ state. Thus, the controller and the programming needs to test the system by querying the same (or other) PID for a period of time or for a number of queries sufficient to distinguish an ECU ‘reset’ from a journey status changing to ‘ended’, and to avoid a false determination of journey ‘ended’ state.

An effective real-world system to infer vehicle journey status should take these facts into account and gracefully handle deviations from expected responses using appropriate software algorithms.

In general, to reliably and quickly detect that the status of a vehicle that is ‘underway’ has changed to ‘ended’, more than one PID ought to be queried. When a value is returned by the network from a PID that can be used to infer a state or status of the journey as ‘ended’ (an initial returned value), the controller immediately repeats the query of that particular parameter in order to confirm the inferred state. When there is no response (absence of a response) to a query of a PID, the controller queries the PID one or more additional times, to determine whether the vehicle has gone from an ‘underway’ state to an ‘ended’ state, or has experienced an ECU ‘reset’.

An effective real-world system also needs to monitor the responses to the queries, and to confirm that the responses indicate that the journey status has changed from ‘underway’ to ‘ ended’, within an amount of time that permit the system to issue an alarm or to take other action as appropriate. In one aspect of the invention, the confirmation of the ‘ended’ state is made within an amount of time sufficient to ensure that an alarm is emitted to catch the attention of the driver of the vehicle before the driver departs the vehicle. Preferably, that amount of time is three seconds or less, and preferable two seconds or less, including about a second or less.

The controller is configured to operate in a first mode, denoted a monitoring mode, where the querying of PIDs comprises continuously repeating a predetermined or random pattern of one or a plurality of PIDs (monitoring parameters), preferably at all times, while the vehicle journey is ‘underway’. In the monitoring mode, each response to a queried parameter, or lack thereof, is evaluated or tested to determine if the response infers that the vehicle journey may have changed from ‘underway’ to ‘ended’, by comparing the response to an inferring response or parameter value selected from a group or a set of inferring responses or parameter values. The group or set of inferring responses or parameter values can include or consist of: (1) the absence of a response to a parameter query, (2) a zero value, and (3) a non-changing (or identical), nonzero value. A response to the query of any of the one or more PIDs (monitoring parameters) can be any one or more of the group or set of inferring responses or parameter values.

In the monitoring mode, whenever any parameter PID is queried and no reply is received, that PID can be flagged as a ‘candidate parameter”. In one aspect of the invention, the lack of response to a query is a prima facie inference that an ECU has shut down, that the vehicle has been shut down, and that the journey has ‘ended’ (barring an ECU ‘reset’).

In the monitoring mode, when a value returned for a monitored parameter has a value of zero (“0″), then that PID may be flagged as a ‘candidate parameter”, depending upon the particular PID used. In some makes and models of vehicles, a particular PID response value of zero may infer an ‘ended’ state, while in other makes and models of vehicles, the same value of zero may not. For example, in most makes and models of vehicles powered by internal combustion engines (ICEs), a returned value of zero for the PID for engine RPM can infer ‘ended’ state, while conversely a returned value of zero for the PID for Vehicle Speed occurs when the vehicle stops at a red light. In a hybrid vehicles, a returned value of zero for the PID for engine RPM does not infer ‘ ended’ state, since the hybrid vehicle may be proceeding on its journey using only battery power. Consequently, the response of zero to a query for the PID for RPM is not sufficiently reliable for all makes and models and types of vehicles. For many other parameters, a returned value of zero may be rare at any time; for example, for air or coolant temperature, while for other parameters, a returned value of zero may be possible when the vehicle has been shut down; for example, for fuel rate or oil pressure.

In the monitoring mode, when the value returned for a monitored parameter is identical to the value last returned for the same monitored parameter, then that PID can be flagged as a “candidate parameter”. In many or most makes and models of vehicles, a particular PID response value that is identical to the value last returned for that particular PID infers an ‘ended’ state, because the likelihood of consecutive values for two dynamic parameter values during normal operation is statistically rare. In the case of the parameter RUNTIME, it has been determined that once a vehicle journey is ‘underway’, the dynamic value (in second) returned for the PID RUNTIME may not increment and will return an identical value for a span of time of up to 10 seconds, and with the next response will increment or catch-up to the expected actual value, and continue to return such actual value for another span of time. Consequently, for RUNTIME, a returned non-zero value that is identical to the last returned for the PID RUNTIME cannot be relied upon as a candidate parameter. On the other hand, some makes and models of vehicles will return a value of zero for the parameter RUNTIME either immediately or after a span of time once the vehicle has been shut down.

Once any monitoring parameter is flagged as a candidate parameter, the controller can be configured to immediately begin operating in a second mode, denoted a confirming mode.

In a first embodiment of a confirming mode, the microprocessor is configured to promptly or immediately query the candidate parameter one or more times sequentially for a predefined term, and to test each response to the query of the candidate parameter, by comparing such response or response value to the set of inferring responses or parameter values. The predefined term can be a predefined number of successive queries only of the candidate parameter, or can be any number of successive queries only of the candidate parameter within a predefined time period. For example, the microcontroller is programmed to “hit” or query the candidate parameter a plurality of successive time, for example, five (5) successive times, with each query occurring each 100 msec, thus taking about 500 msec. The period of time between each query can be selected between about 100 msec to about 500 msec, though the period of time can be shorter or longer depending upon circumstances. The plurality of successive times can be up to ten times, although more can be used. Or the microcontroller is programmed to “hit” the candidate parameter two or more times within a time period of 0.6 seconds, where each query can be made every 200 msec, thus querying the candidate parameter at least three times. The time period can be at least about 0.5 seconds, and up to one second, including up to 2 seconds, or up to 3 seconds, and up to 10 seconds, although more can be used.

Each confirmational query of the candidate parameter is tested in succession. If the response to the first query of the candidate parameter in the confirming mode is one of the inferring responses (or lack thereof) or parameter values, and more particularly the same inferring response or parameter value that had flagged the candidate parameter, the inference remains and the next successive conformational query is made. If each of the conformational queries during the predefined term is the same inferring ‘lack of response’ or inferring parameter value, then the inferred state of the vehicle journey is confirmed and is identified as ‘ended’. On the other hand, if any of the conformational queries returns a parameter value that is not the same inferring response (for example, is a dynamic and non-identical, non-zero response value), then the confirming mode is canceled, and the microcontroller and the system returns to the monitoring mode.

In another embodiment of a confirming mode, after the first candidate parameter has been re-queried one or more times and each response returns the same inferring response or parameter value that flagged the candidate parameter, the system can then “hit” a second of the other monitoring parameter, as a second candidate parameter, to determine or confirm that the response to such other monitoring parameter is also an inferring response or parameter. If each of the conformational queries of the second candidate parameter is a same inferring response or parameter value, then the state of the vehicle journey can be identified as ‘ended’. On the other hand, if any of the conformational queries of the second candidate parameter returns a parameter value that not the same inferring response (for example, is a dynamic and non-identical, non-zero value), then the confirming mode is canceled, and the microcontroller and the system returns to the monitoring mode.

In yet another embodiment of a confirming mode, the monitoring mode can be continued one or more cycles of the monitoring parameters, to determine if a second of the plurality of monitoring parameters is flagged as a candidate parameter. A determination that at least two of the monitoring parameters are also candidate parameters can be used to decide that the vehicle journey is ‘ended’.

Of note, beyond the mandated PIDs listed in Table A, various manufacturers respond to hundreds and in some cases thousands of proprietary PIDs on their vehicle networks. For a device targeted at a specific manufacturer's vehicles, it is possible to duplicate the above functionality with manufacturer-specific PIDs in place of the mandated PIDs listed.

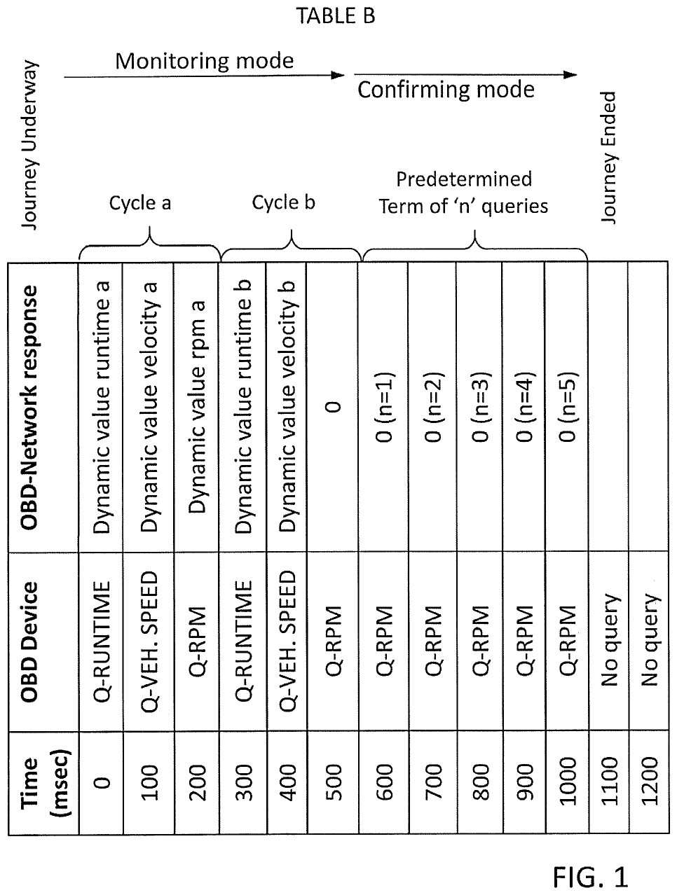

A non-limiting example of a monitoring mode and a determining mode by a controller device on a vehicle for inferring and determining the journey status of the vehicle is illustrated in Table B (FIG. 1). Table B shows the network traffic between a controller device plugged into the OBD-II port of a vehicle and the vehicle's ECUs. The portable controller device queries the vehicle network in a monitoring mode with a repeating cycle of PIDs consisting of RUNTIME, VEHICLE SPEED and RPM in series, at 100 msec each, continuously and/or successively during the ‘underway’ journey of the vehicle. In the monitoring mode, the querying includes monitoring the parameter ‘RPM’ for an inferring parameter value of zero (“0”). The querying can further include monitoring the other additional parameters ‘RUNTIME’ and ‘VEHICLE SPEED’ independently and selectively for any one or more of the set of inferring responses or parameter values. At an arbitrary time near the end of the journey, shown at time 0, the controller queries the network in a cycle ‘a’ of RUNTIME, VEHICLE SPEED and RPM over the time period 0-300 msec. During a cycle ‘b’ in the monitoring mode, the query of RPM returned a value of zero, which was compared with and found to fulfill the inferring parameter value for RPM being zero. The controller responds by initiating a confirming mode in which the same RPM PID is queried successively five additional times, each query within 100 msec beginning at time 600 msec. The network returns a value of zero for each of the five queries of the RPM PID, and the controller confirms the inference and determines that the vehicle journey has changed from ‘underway’ to ‘ended’ at time 1100 msec. The time from the last dynamic value of parameter RPM (“rpm a”) to the determination that the journey has ended, is about 700 msec. On the other hand, if any of the responses to the five successive queries of RPM was not a zero, then the controller will terminate the confirming mode and will reinitiate the monitoring mode.

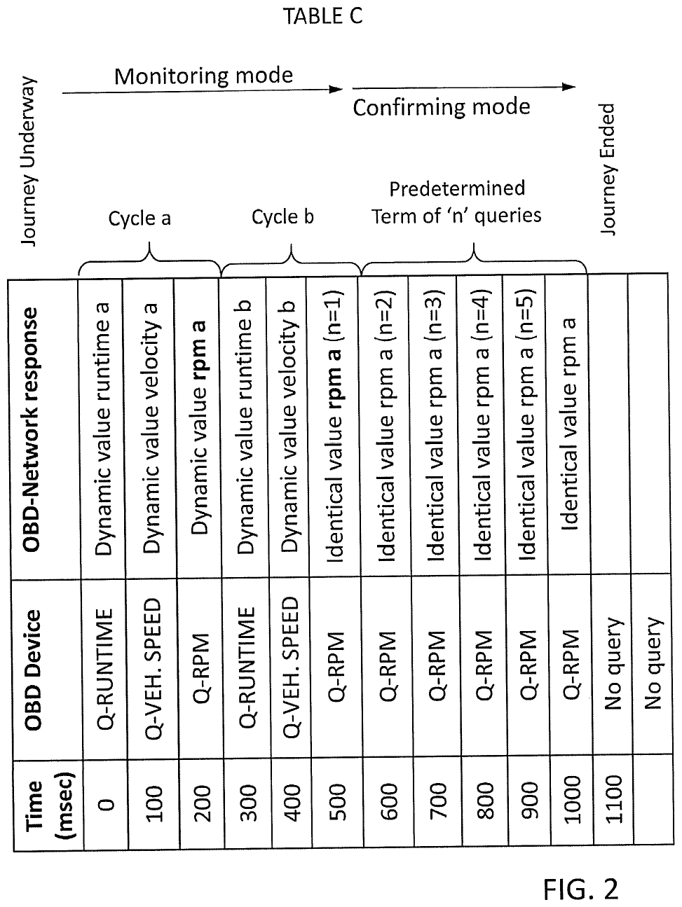

Another non-limiting example of a monitoring mode and a determining mode by a controller device on a vehicle for inferring and determining the journey status of the vehicle is illustrated in Table C (FIG. 2). Table C shows the network traffic between a controller device plugged into the OBD-II port of a vehicle and the vehicle's ECUs. The portable controller device queries the vehicle network in a monitoring mode with a repeating cycle of PIDs consisting of RUNTIME, VEHICLE SPEED and RPM in series, at 100 msec each, continuously and/or successively, during the ‘underway’ journey of the vehicle. In the monitoring mode, the querying includes monitoring the parameter ‘RPM’ for an inferring parameter value of an identical, nonzero value. The querying can further include monitoring the other additional parameters ‘RUNTIME’ and ‘VEHICLE SPEED’ independently and selectively for any one or more of the set of inferring responses or parameter values. At an arbitrary time near the end of the journey, shown at time 0, the controller queries the network in a cycle ‘a’ of RUNTIME, VEHICLE SPEED and RPM over the time period 0-300 msec, with the value for RPM being a non-zero value “rpm a”. During a cycle ‘b’ in the monitoring mode, the query of RPM returned an identical value of “rpm a”, which was compared with the preceding value of RPM and found to fulfill the inferring parameter value of the RPM PID, being a first identical, non-zero value. The controller responds by initiating a confirming mode in which the same RPM PID is queried successively four additional times, each query within 100 msec beginning at time 600 msec. The network returns an identical non-zero value of “rpm a” for each of the four additional queries of the RPM PID, and the controller confirms the inference and determines that the vehicle journey has changed from ‘underway’ to ‘ended’. The time from the last non-identical dynamic value of parameter RPM (time=0 msec) to the determination that the journey has ended, is about 1100 msec. On the other hand, if any of the responses to the four successive queries of RPM was not an identical non-zero value of “rpm a”, then the controller will terminate the confirming mode and will reinitiate the monitoring mode.

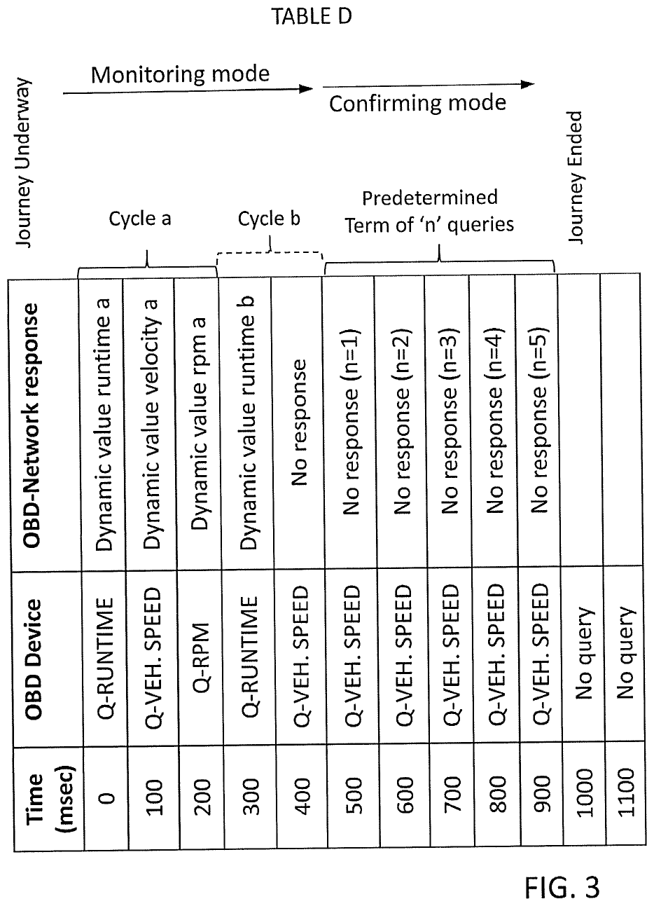

A further non-limiting example of a monitoring mode and a determining mode by a controller device on a vehicle for inferring and determining the journey status of the vehicle is illustrated in Table D (FIG. 3). Table D shows the network traffic between a controller device plugged into the OBD-II port of a vehicle and the vehicle's ECUs. The portable controller device queries the vehicle network in a monitoring mode with a repeating cycle of PIDs consisting of RUNTIME, VEHICLE SPEED and RPM in series, at 100 msec each, continuously and/or successively, during the ‘underway’ journey of the vehicle. In the monitoring mode, the querying includes monitoring the parameter ‘VEHICLE SPEED’ for an inferring parameter response of “no response”. The querying can further include monitoring the other additional parameters ‘RPM’ and ‘RUNTIME’ independently and selectively for any one or more of the set of inferring responses or parameter values. At an arbitrary time near the end of the journey, shown at time 0, the controller queries the network in a cycle ‘a’ of RUNTIME, VEHICLE SPEED and RPM over the time period 0-300 msec. During a cycle ‘b’ in the monitoring mode, the query of RPM returned a value of zero, which was compared with and found to fulfill the inferring parameter value for RPM being zero. The controller responds by initiating a confirming mode in which the same RPM PID is queried successively five additional times, each query within 100 msec. The network returns a value of zero for each of the five queries of the RPM PID, and the controller confirms the inference and determines that the vehicle journey has changed from ‘underway’ to ‘ended’. The time from the “no response to the parameter VEHICLE SPEED to the determination that the journey has ended, is about 700 msec. On the other hand, if any of the responses to the five subsequent successive queries of VEHICLE SPEED was a parameter value (not a “no response”), then the controller will terminate the confirming mode and will reinitiate the monitoring mode.

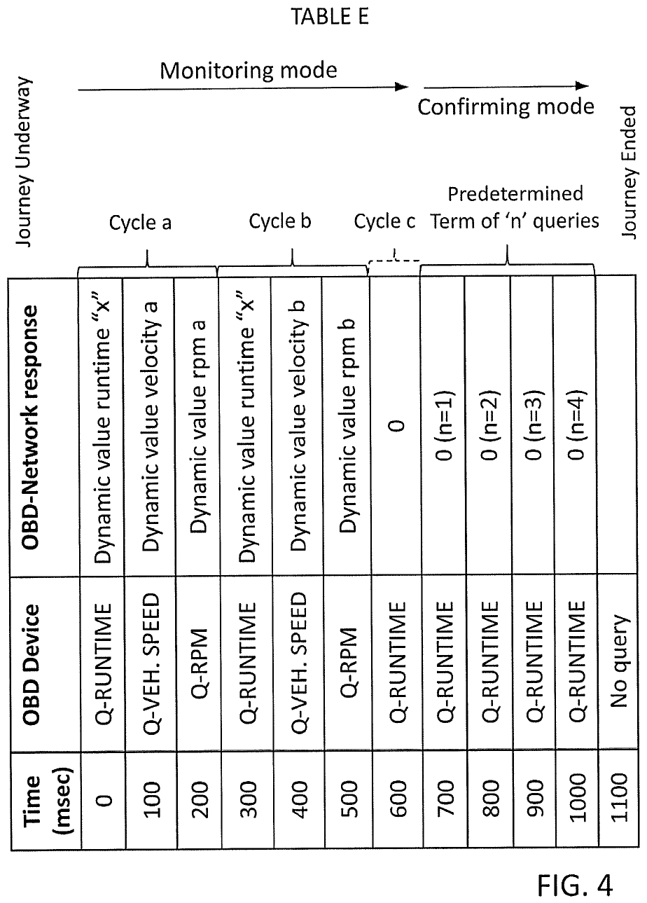

Another non-limiting example of a monitoring mode and a determining mode by a controller device on a vehicle for inferring and determining the journey status of the vehicle is illustrated in Table E (FIG. 4). Table E shows the network traffic between a controller device plugged into the OBD-II port of a vehicle and the vehicle's ECUs. The portable controller device queries the vehicle network in a monitoring mode with a repeating cycle of PIDs consisting of RUNTIME, VEHICLE SPEED and RPM in series, at 100 msec each, continuously and/or successively, during the ‘underway’ journey of the vehicle. In the monitoring mode, the querying includes monitoring the parameter ‘RUNTIME’ for an inferring parameter value of an identical, non-zero value. The querying can further include monitoring the other additional parameters ‘RPM’ and ‘VEHICLE SPEED’ independently and selectively for any one or more of the set of inferring responses or parameter values. At an arbitrary time near the end of the journey, shown at time 0, the controller queries the network in a cycle ‘a’ of RUNTIME, VEHICLE SPEED and RPM over the time period 0-300 msec. The parameter RUNTIME is returning a parameter value “x” over a period of time. During a cycle ‘b’ in the monitoring mode, the query of RUNTIME returned a value of zero, which was compared with the preceding value of RUNTIME as value “x” and found to fulfill the inferring parameter value of the RPM RUNTIME, being a zero value following a non-zero value. The controller responds by initiating a confirming mode in which the same RUNTIME PID is queried successively four additional times, each query within 100 msec beginning at time 700 msec. The network returns a zero value for each of the four additional queries of the RUNTIME PID, and the controller confirms the inference and determines that the vehicle journey has changed from ‘underway’ to ‘ended’. The time from the last dynamic value of parameter RUNTIME (time=400 msec) to the determination that the journey has ended, is about 700 msec.

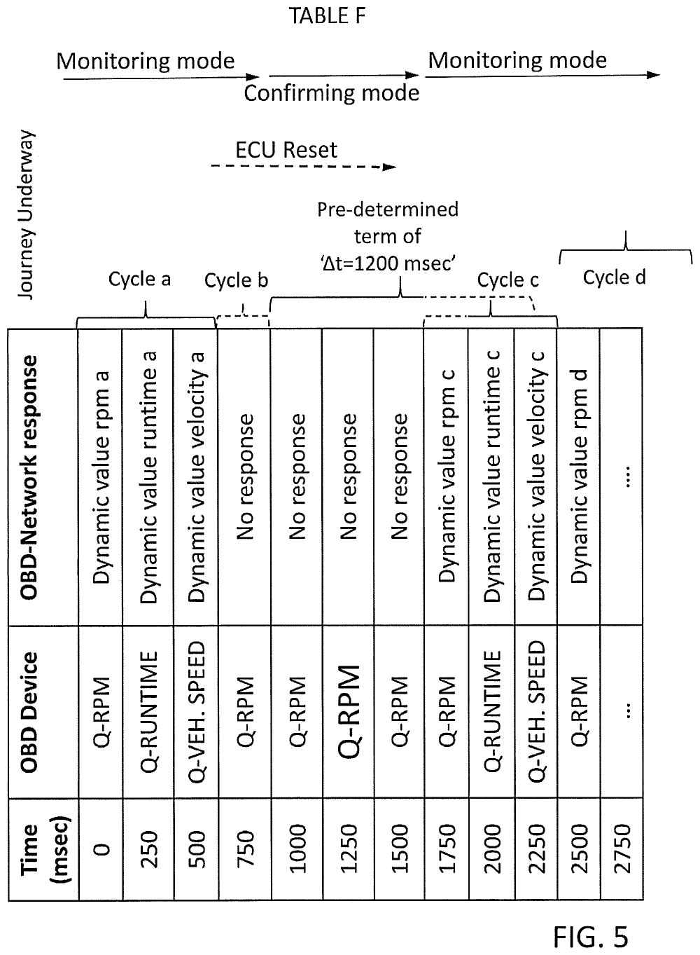

A further non-limiting example of a monitoring mode and a determining mode by a controller device on a vehicle for inferring and determining the journey status of the vehicle is illustrated in Table F (FIG. 5). Table F shows the network traffic between a controller device plugged into the OBD-II port of a vehicle and the vehicle's ECUs. The portable controller device queries the vehicle network in a monitoring mode with a repeating cycle of PIDs consisting of RUNTIME, VEHICLE SPEED and RPM in series, at 250 msec each, continuously and/or successively, during the ‘underway’ journey of the vehicle. In the monitoring mode, the querying includes monitoring the parameter ‘RPM’ for an inferring response of “no response”. The querying can further include monitoring the other additional parameters ‘RUNTIME’ and ‘VEHICLE SPEED’ independently and selectively for any one or more of the set of inferring responses or parameter values. At an arbitrary time near the end of the journey, shown at time 0, the controller queries the network in a cycle ‘a’ of RUNTIME, VEHICLE SPEED and RPM over the time period 0-750 msec. During a cycle ‘13’ in the monitoring mode, the query of RPM returned ‘no response’, which was compared with and found to fulfill the inferring response for RPM of “no response”. The controller responded by initiating at t=1000 msec a confirming mode in which the same RPM PID is queried successively additional times, for a pre-determined term of 1200 msec. The network fails to respond for three queries of the RPM PID, but on the fourth query at t=1750 msec, the RPM PID returns a dynamic value of ‘rpm c’, from which can be inferred that the ECU had ‘reset’. The controller and its programming cancels the confirming mode, maintains the vehicle journey as ‘underway’, and initiates the monitoring mode.

In an embodiment of the invention, a first predetermined monitoring parameter is RPM, and the predetermined inferring response or parameter value that is compared against the response by the network to the query for RPM can include an absence of a response to the query of said monitoring parameter, a zero value, and an identical non-zero value, and when any response by the network to the query for RPM is or satisfies an absence of a response to the query of the monitoring parameter, or a zero value, or an identical non-zero value, then the RPM parameter is defined as a candidate parameter, and the predetermined inferring response or parameter value that has been satisfied is selected as the predetermined inferring response or parameter value for a confirming mode.

A second predetermined monitoring parameter is Vehicle Speed, and the predetermined inferring response or parameter value that is compared against the response by the network to the query for Vehicle Speed includes an absence of a response to the query of the monitoring parameter, and an identical non-zero value, and when any response by the network to the query for Vehicle Speed is or satisfies an absence of a response to the query of said monitoring parameter, or an identical non-zero value, then the Vehicle Speed parameter is defined as a candidate parameter, and the predetermined inferring response or parameter value that has been satisfied is selected as the predetermined inferring response or parameter value for a confirming mode.

A third predetermined monitoring parameter is RUNTIME, and the predetermined inferring response or parameter value that is compared against the response by the network to the query for RUNTIME includes an absence of a response to the query of said monitoring parameter, and a zero value, and when any response by the network to the query for RUNTIME is or satisfies an absence of a response to the query of said monitoring parameter, or a zero value, then the RUNTIME parameter is defined as a candidate parameter, and the predetermined inferring response or parameter value that has been satisfied is selected as the predetermined inferring response or parameter value for a confirming mode.

It should be understood that in another (or other suitable parameter) example of the monitoring mode, two or more inferring parameter values can be used concurrently. For example, during a monitoring mode, the parameter ‘RPM’ (or other suitable parameter) can be monitored for an inferring parameter value of both zero and an identical, non-zero value, the parameter ‘VEHICLE SPEED’ (or other suitable parameter) can be monitored for an inferring parameter response of “no response”, and the parameter ‘RUNTIME’ can be monitored for an inferring parameter response of zero value, following a dynamic non-zero value.

### The Portable Controller Device

The portable controller device can include an interface that plugs into the OBD-II port, and a housing that contains the hardware and programming for querying the vehicle network for the predetermined parameters, using software or a network interpreter chip, or both. The housing can also contain an RF or other signal transmission receiver, RF or other signal transmission transmitter, a combined transmitter/receiver device (transceiver), and an alarm signal generator. The alarm signal generator can include the alarm, or can communicate with the vehicle to generate the alarm, wherein the alarm can include an audible voice, music, or tone, a buzzer, the vehicle's car theft alarm, the vehicle ignition, the vehicle heater, the vehicle air conditioner, the vehicle power door system, the vehicle power window system, the vehicle sound system or radio, the vehicle horn, the vehicle light systems including the compartment lights, headlights, warning lights, and taillights, the vehicle information display, and the vehicle wireless, cellular or satellite communication system. The interface can be housed in the housing, or can be connected to the housing with a wire connection.

The alarm signal generator of the portable controller device can generate the alarm signal when the status of the buckle status signal is buckled and the status of the vehicle journey has changed to ‘ended’ for beyond a predetermined time period. The alarm then responds to the alarm signal after a second predetermined time period. The status of the vehicle's battery system can include the battery voltage potential, the voltage signal quality of the rectified DC, and a vehicle operation parameter. The buckle status signal can be a radio frequency signal that includes an encryption code, a unique identity (ID) code for the buckling detector, a “buckled” and/or “unbuckled” signal code, and optionally a battery voltage check code, an ambient temperature check code, and a CRC code.

The microcontroller of the portable controller device (or on-board native controller device) can be configured to query the vehicle network, by software or by control of a network interface chip, for the selected parameters using PIDs. The microcontroller can include a stored program fixed in non-transient media. The microcontroller can be configured to query for each selected parameter sequentially or intermittently. The microcontroller can be configured to query for one or more selected parameters more frequently than other selected parameters. The microcontroller can be configured to not query for a selected parameter unless a preselected value is returned for another parameter that has been queried. The microcontroller can also be configured to minimize the frequency and duration of queries to the vehicle network so as to minimize or avoid overload or delay other operations or vital functions performed by the vehicle network.

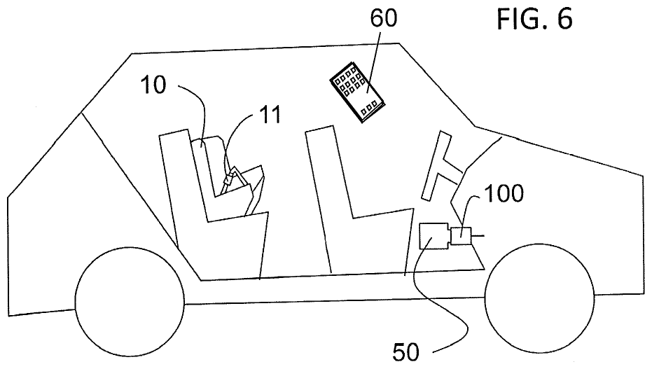

FIG. 6 shows a portable controller device 50 that plugs into the OBD-II port 100 of the vehicle. A child safety seat 10 is shown in a rear passenger seat of the vehicle, with a buckle signaling device 11 that includes a buckling detector for detecting the buckling, and the unbuckling, of a latch into the buckle, a buckle status processor, and buckle status signal transmitter for transmitting a wireless signal when the status of the buckling changes from unbuckled to buckled, and buckled to unbuckled. The buckling detector can be integral with, or separate from, the restraint mechanism associated with the child safety seat. The buckle status signal is typically a wireless signal, and can include a radio frequency (RF) signal that contains at least the restraint device identification information. Non-limiting examples of wireless signals and systems include Bluetooth® and Bluetooth® LE (Bluetooth® Smart) operating in the 2.4 GHz range, and RF transmitters and transceivers in the 400-900 MHz range. A smartphone 60 is illustrated in the vicinity of the vehicle, presumed in the possession of a driver (not shown).

Other optional features of the portable controller device can include an audio speaker from which audible signals, warnings, and alarms can be emitted to the attention of the driver or other passengers or persons in the vicinity of the device or the vehicle. The device can also include a reset button for returning any information in volatile memory back to a standard or factory setting, or other previously established setting or condition. The user can be permitted to add or update programming using a computer or other data-entry device that interfaces with the portable controller device wirelessly or through an updating port. Other optional components that can disposed on or within the housing of the portable controller device including a “power on” LED indicator, an operating mode LED(s), an on-board ‘learn’ button, a ‘pause’ or ‘delay’ button, user selection switches, as well as microcontroller pin requirements and connections.

In another embodiment of the invention, a native or on-board controller device can query the network for one or more predetermined parameters using PIDs, receive responses from the network of the parameter values, and analyze the parameter values to infer status of the vehicle journey, including as ‘underway’ or as ‘ended’. From the inferred journey status, the on-board controller device can broadcast the inferred status of the journey to the driver, to another device or to a communication system, or can emit an alarm or warning signal in at least partial response to the inferred status to the driver or the journey. For example, a vehicle manufacturer could modify current vehicle onboard processor software and use the vehicle's remote keyless entry (RKE) antenna to duplicate the functionality of the portable onboard controller. In accordance with other aspects of the disclosure, the vehicle's entertainment/information (“infotainment”) system, and/or its Bluetooth or WiFi systems, and/or its OBD-II subsystem may be utilized to achieve the desired functionality.

TABLE A

| Hexidecimal | Decimal | Description |
|---|---|---|
| 00 | 00 | List of PIDs supported (range 01 to 32) |
| 01 | 01 | Status since the last clearing of fault codes |
| 02 | 02 | Fault code that caused the recording of “freeze |
| | | frame” data |
| 03 | 03 | Fuel system status |
| 04 | 04 | Engine load calculated in % |
| 05 | 05 | Temperature of the engine coolant in ° C. |
| 06 | 06 | Short-term fuel % trim bank 1 |
| 07 | 07 | Long-term fuel % trim bank 1 |
| 08 | 08 | Short-term fuel % trim bank 2 |
| 09 | 09 | Long-term fuel % trim bank 2 |
| OA | 10 | Fuel pressure in kPa |
| OB | 11 | Intake manifold absolute pressure in kPa |
| OC | 12 | Engine speed in rpm |
| OD | 13 | Vehicle speed in kph |
| OE | 14 | Timing advance on cylinder 1 in degrees |
| OF | 15 | Intake air temperature in ° C. |
| 10 | 16 | Air flow measured by the flowmeter in g/s |
| 11 | 17 | Throttle position in % |
| 12 | 18 | Status of the secondary intake circuit |
| 13 | 19 | 02 sensor positions bank/sensor |
| 14 | 20 | Oxygen sensor volts bank 1 sensor 1 |
| 15 | 21 | Oxygen sensor volts bank 1 sensor 2 |
| 16 | 22 | Oxygen sensor volts bank 1 sensor 3 |
| 17 | 23 | Oxygen sensor volts bank 1 sensor 4 |
| 18 | 24 | Oxygen sensor volts bank 2 sensor 1 |
| 19 | 25 | Oxygen sensor volts bank 2 sensor 2 |
| 1A | 26 | Oxygen sensor volts bank 2 sensor 3 |
| 1B | 27 | Oxygen sensor volts bank 2 sensor 4 |
| 1C | 28 | OBD computer specification |
| 1D | 29 | O2 sensor positions bank/sensor |
| 1E | 30 | Auxiliary input status |
| 1F | 31 | Run time since engine start |

1. A vehicle notification system for communicating with a driver of a passenger vehicle, after the vehicle's driving journey has ended, that a child, pet or valued object remains present within the vehicle, comprising:
a) at least one detection device including a means for detecting a presence or a restraint of a child, pet or valued object, within the vehicle, and a transmitter configured to transmit a presence/restraint status signal;
b) a portable controller device that attaches to the On-Board Diagnostic II (OBD-II) port of the vehicle, including a microcontroller, a network interface, a transceiver, the microcontroller configured to interact with the network of the vehicle to determine the status of the vehicle journey as being underway or ended, and the transceiver configured to receive the presence/restraint status signal transmitted by the detection device, and to transmit a vehicle journey status signal and a presence/restraint status signal; and
c) a mobile communication device in the possession of the driver or other vehicle occupant, that includes a microprocessor that incorporates a software application, and a transceiver, wherein the software application configures the transceiver to receive the vehicle journey status signal and the presence/restraint status signal transmitted by the controller device, and wherein the software application generates an alarm signal in response to a predetermined condition of the presence/restraint status and the vehicle journey status.

2. The vehicle notification system according to claim 1 wherein the predetermined condition of the presence/restraint status is an active status wherein the detecting means detects the presence or the restraint of the child, pet or valued object within the vehicle, and the predetermined condition of the vehicle journey status is an ended vehicle journey.

3. The vehicle notification system according to claim 1 wherein the mobile communication device is a smartphone, and the transceiver of the smartphone includes a Bluetooth® or Bluetooth® LE transceiver operating in the 2.4 GHz range.

4. The vehicle notification system according to claim 3 wherein the software application of the smartphone configures the Bluetooth® transceiver to transmit a notification signal intermittently while the software application is running on the smartphone, which can be received by the controller device, to notify the controller device that the smartphone is in the vicinity of the controller device.

5. The vehicle notification system according to claim 4 wherein the controller device is configured selectively to generate an alarm signal in response to a predetermined condition of the vehicle journey status and the presence/restraint status when the notification signal from the smartphone has not been received for a period of time.

6. The vehicle notification system according to claim 4 wherein the transceiver of the smartphone can be configured to activate the software application in response the receipt of a signal transmitted by the controller device, the transmitted signal selected from the group consisting of the vehicle journey status signal and the presence/restraint status signal.

7. The vehicle notification system according to claim 1 wherein the alert signal generated by the mobile communication device is selected from the group consisting of a visual message or signal on a display, a visual signal on a light source, an audible message or signal, or an electronic broadcast of a message or signal to a third party mobile communication device or network device.

8. The vehicle notification system according to claim 7 wherein the controller device is configured to continuously monitor for a notification signal transmitted by the mobile communication device, or smartphone, and to emit an alarm signal in response to the predetermined condition of the vehicle journey status and the presence/restraint status, if the controller device has not detected a notification signal from the smartphone for more than a period of time.

9. The vehicle notification system according to claim 1 wherein the detection device includes a device for sensing or detecting the actual or inferred presence of the child, pet or valued object, based on a physical parameter of the child, pet or valued object, or a device for inferring the presence of the child, pet or valued object, based on the status of a restraint device as either being engaged or disengaged, or a device including a means for fastening or attaching the detection device to the child, pet, or valued object, and means for transmitting the detection status signal.

10. The vehicle notification system according to claim 3 wherein the software application of the smartphone configures the Bluetooth® transceiver to detect whether the controller device is engaged and detecting the smartphone presence.

11. The vehicle notification system according to claim 10 wherein the controller device is configured selectively to generate an alarm signal in response to a predetermined condition of the vehicle journey status and the presence/restraint status when the smartphone is determined to have lost contact after initially detecting the smartphone presence for a period of time.

12. A vehicle notification system for communicating with a driver of a passenger vehicle, after the vehicle's driving journey has ended, that a child, pet or valued object remains present within the vehicle, comprising:
a) at least one detection device including a means for detecting a presence or a restraint of a child, pet or valued object, within the vehicle, and a transmitter configured to transmit a presence/restraint status signal;
b) a controller that either attaches to the On-Board Diagnostic II (OBD-II) port of the vehicle or is programmed from the vehicle's current vehicle onboard processor software and uses the vehicle's remote keyless entry (RKE) antenna, entertainment/information (“infotainment”) system, Bluetooth or WiFi systems, and/or its OBD-II subsystems, including a microcontroller, a network interface, a transceiver, the microcontroller configured to interact with the network of the vehicle to determine the status of the vehicle journey as being underway or ended, and the transceiver configured to receive the presence/restraint status signal transmitted by the detection device, and to transmit a vehicle journey status signal and a presence/restraint status signal; and
c) a mobile communication device in the possession of the driver or other vehicle occupant, that includes a microprocessor that incorporates a software application, and a transceiver, wherein the software application configures the transceiver to receive the vehicle journey status signal and the presence/restraint status signal transmitted by the controller device, and wherein the software application generates an alarm signal in response to a predetermined condition of the presence/restraint status and the vehicle journey status.

13. A method for notifying a driver or other vehicle occupant that a child, a pet or a valued object remains present or restrained within the vehicle after journey of the vehicle has ended, comprising the steps of:
i) providing a detection device, controller device, and smartphone operating the software program, as described above;
ii) positioning a child, pet or valued object in a vehicle, detecting by the detection device that the child, pet or valued object positioned in the vehicle is present or restrained, and transmitting by the transmitter of the detection device, an active detection signal;
iii) receiving by the transceiver of the controller device, the active detection signal sent by the detection device, and re-transmitting intermittently by the transceiver of the controller device, the active detection signal for receipt by the smartphone;
iv) receiving by the transceiver of the smartphone, the active detection signal sent by the controller device, and entering an active detection status into memory;
v) driving the vehicle by a driver to establish a vehicle status as ‘underway’;
vi) terminating by the driver of the vehicle journey, and detecting the change in vehicle journey status as ‘ended’, and transmitting by the controller device of the ended journey status signal for receipt by the smartphone;
vii) receiving by the transceiver of the smartphone, the ended journey status signal sent by the controller device, and entering an ended journey status into memory;
viii) determining by the smartphone the condition that the journey has ended and that the child, pet or valued object remains present or restrained in the vehicle, and activating an alert signal for a predetermined period of time;
ix) terminating the alert signal if the child, pet or valued object is removed or released from the vehicle, and an inactive detection signal transmitted by the detection device, and re-transmitted by the controller device, is received by the smartphone; and
x) generating an alarm signal by the smartphone if an inactive detection signal is not received by the smartphone within the predetermined period of time.

14. The method according to claim 13 wherein the controller device intermittently and continuously transmits the vehicle journey status signal and the presence/restraint status signal.

15. The method according to claim 13 wherein the controller device terminates the transmission of the ended journey signal after a set time if the presence/restraint status was inactive when the vehicle journey ended, or if the presence/restraint status changed from ‘active’ to ‘inactive’ after the vehicle journey status changed from ‘underway’ to ‘ended’
